(19) United States
(12) Patent Application Publication
(10) Pub. No.: US 2024/0125930 A1
(43) Pub. Date: Apr. 18, 2024

(54) METHOD FOR DETECTING AN OBJECT BY A TIME-OF-FLIGHT SENSOR

(71) Applicants: STMicroelectronics (Grenoble 2) SAS, Grenoble (FR); STMicroelectronics Design and Application S.R.O., Prague (CZ); STMicroelectronics (Alps) SAS, Grenoble (FR)

(72) Inventors: Robin VASSAL, Grenoble (FR); Jiri ANDRLE, Praha (CZ); Peter CABAJ, Prague (CZ); Cyrille TROUILLEAU, Lans en Vercors (FR)

(73) Assignees: STMicroelectronics (Grenoble 2) SAS, Grenoble (FR); STMicroelectronics Design and Application S.R.O., Prague (CZ); STMicroelectronics (Alps) SAS, Grenoble (FR)

(21) Appl. No.: 18/377,893

(22) Filed: Oct. 9, 2023

(30) Foreign Application Priority Data
Oct. 14, 2022 (FR) 2210586

(51) Int. Cl. G01S 17/08; G01S 7/497

(52) U.S. Cl. CPC G01S 17/08; G01S 7/497

(57) ABSTRACT

A method is for detecting one or more objects in a detection zone using a time-of-flight sensor. The method includes emitting optical radiation via the emission circuitry of the sensor and subsequently capturing the reflected optical radiation using the reception circuitry. This captured radiation is quantified in terms of photons, and measurement circuitry determines both the amount of these photons and the distance from the sensor to the object(s). An analysis of the photon count, combined with the calculated distance, is used to determine the presence or absence of objects within the detection zone.

### PRIORITY CLAIM

This application claims the priority benefit of French Application for Patent No. 2210586, filed on Oct. 14, 2022, the content of which is hereby incorporated by reference in its entirety to the maximum extent allowable by law.

### TECHNICAL FILED

Embodiments and implementations relate to object detection by devices, in particular the detection of an object in a detection zone by a time-of-flight sensor.

### BACKGROUND

A time-of-flight sensor is a sensor that uses light propagation to measure a distance between an object and the sensor. In particular, the time-of-flight sensor is configured to emit optical radiation, for example of an infra-red or a laser radiation type, towards an object and to measure a time of flight, that is, the time elapsed between the emission of this radiation and its reception by the sensor after the radiation has been reflected from the object. By measuring the time of flight, the distance between the object and the sensor can be determined, since the speed of the radiation (speed of light) is known.

Other known devices enable an object to be detected from optical radiation such as, for example, devices employing an optical barrier. The optical barrier typically has a group of LEDs and an array of photodiodes, each of which continuously receives the optical radiation emitted by a LED. The array of photodiodes enables the return of Boolean data depending on whether an object has been detected, that is, when a photodiode no longer receives radiation, or not, in the opposite case.

However, these devices are often more expensive and complex since the optical barrier is an application that may require the use of an application-specific integrated circuit, usually referred to by the acronym “ASIC”, and a large amount of computational power related to the amount of data to be processed by a high number of photodiodes, which may lead to excessive energy consumption. Furthermore, the detection rate of these devices is often limited, rarely exceeding 90%.

Besides, it is known that the algorithms implemented in the time-of-flight sensor are likely to generate erroneous results commonly referred to as “false positives” when they indicate the presence of an object by mistake. Other erroneous results may arise from a failure to detect objects that are mistaken for the sensor environment, such as for example walls, located in the detection zone of the sensor. These algorithms do not achieve a detection rate sufficient to avoid these erroneous results and to enable the detection of objects in any environment, especially objects in the vicinity of walls.

Furthermore, the detection of the sensor is limited when these algorithms are used as they do not enable the sensor to detect small objects such as coins or dust particles. Dust particles, once accumulated in the detection zone, can be as much of a problem as other larger objects in some applications such as the display of data on a screen where parts of the screen may be obscured by these objects.

Thus, there is a need to provide object detection solutions for improving object detection.

### SUMMARY

According to one aspect, a method is provided for detecting at least one object in a detection zone of a time-of-flight sensor. The method includes emitting optical radiation by emission circuitry of the time-of-flight sensor, receiving by reception circuitry of the time-of-flight sensor an amount of photons of optical radiation reflected by said at least one object, measuring by measurement circuitry of the time-of-flight sensor an amount of photons and a distance between the time-of-flight sensor and said at least one object, and analyzing the amount of detected photons and the associated distance so as to determine the presence of at least one object in the detection zone of the time-of-flight sensor.

A time-of-flight sensor using an object detection algorithm based on an analysis of two types of distinct measurement data is therefore provided. The types of distinct measurement data include an amount of photons detected by the sensor upon reception of the reflected optical radiation and a distance calculated from the time elapsed between the emission and reception of the optical radiation. The analysis relates the two types of data so that the values of these data coincide when an object appears in the detection zone.

By measuring the amount of photons of the reflected radiation and associating this amount to the measured distance, the accuracy of the detection of the object in the detection zone is improved. Indeed, the amount of photons of the reflected radiation also provides information on the position of the object, that is, whether it is more or less close to the sensor, and also varies as a function of the nature of the object, especially due to the material of the object which can influence its optical reflection properties. When the radiation is reflected from an object close to the sensor for example, the amount of photons from the radiation reflected from the object is relatively high as the photons are almost all detected by the sensor. In other words, the ratio of the number of received photons to the number of emitted photons is close to 1 at short distances between the sensor and the object and decreases at longer distances.

When an object is located close to a wall, analyzing the amount of detected photons and the measured distance enables the object to be differentiated from the wall.

Besides, the use of a time-of-flight sensor has advantages in terms of integration, which is less complex than with other photonic sensors, temperature compensation, energy consumption and detection rate, since the time-of-flight sensor can enable the detection of objects of reduced size. For example, the time-of-flight sensor can detect small objects such as a coin when the edge of the coin is located facing the sensor, where the coin may be about 11 mm wide and about 1.5 mm thick. The time-of-flight sensor can also detect objects smaller than a coin, such as dust particles.

The detection method thus takes advantage of a sensor having a wide field of view and an ability to measure several parameters of optical radiation to improve the reliability of the detection.

According to one implementation, analyzing the amount of photons associated with the measured distance includes successively storing N values of amounts of photons and associated distances, calculating a photon amount central trend indicator from the N amounts of photons, and calculating a distance central trend indicator so that said at least one object is detected according to said central trend indicators calculated.

The central trend indicator, such as the average or median, corresponds to a statistical value enabling a relatively accurate estimation of the position of the object to be detected according to a sequence of values of amounts of photons and distances measured. The central trend indicators can be calculated over a number N of amounts of photons and distances measured successively over a time window, that is, a given time interval, which can be sliding. The time interval can be longer or shorter depending on the number N of values of measured amounts of photons and distance to be stored and taken into account in the calculation of the central trend indicators. A high number N makes it possible to limit outliers of certain measurement data generated in the same time interval and thus to avoid producing an erroneous result on the detection of objects in the detection zone.

According to one implementation, said at least one object is detected when the distance central trend indicator is in the distance interval and when the photon amount central trend indicator is in a photon amount interval.

The distance interval includes distance values when no object is present in the detection zone. These values generally correspond to objects that are not of interest to be detected. The distance interval therefore enables these objects to be excluded from detection by the time-of-flight sensor.

The sensor can be parameterized in order to define distance and photon amount intervals for which it is assumed that an object is detected or not in the detection zone.

According to one implementation, the at least one object is detected when the distance central trend indicator is lower than a first distance.

An object relatively close to the time-of-flight sensor can be reliably detected from the measured distance, regardless of the amount of photon with which that distance is associated.

According to one implementation, the photon amount central trend indicator is a median of the N amounts of photons and the distance central trend indicator is a median of the N associated distances.

The calculation of the median value of the amounts of photons and distances can be advantageous in terms of reliability since it reduces the influence of outliers on the detection result.

According to one implementation, the photon amount central trend indicator is an average of the N amounts of photons and the distance central trend indicators is an average of the N associated distances.

The calculation of the average is an alternative to the calculation of the median of the amounts of photons and the associated distances.

According to another aspect, a method is provided for detecting at least one object in a cavity including an opening through which the at least one object can enter and a bottom, a time-of-flight sensor being mounted to a wall of the cavity, the time-of-flight sensor having a detection zone extending between the time-of-flight sensor and a wall of the cavity opposite to the time-of-flight sensor to the bottom of the cavity.

The method comprises an implementation of the previously mentioned method by the time-of-flight sensor so as to detect the presence of said at least one object when it is resting on the bottom of the cavity.

The method can thus be implemented within the context of object detection in a partially closed space whose walls can be detected by the time-of-flight sensor. In this application, the method is particularly advantageous since it enables the detection of an object resting at the bottom of the cavity to be differentiated from a detection of a wall of the cavity by the time-of-flight sensor.

According to one implementation, the detection method includes emitting light beams by a screen located at the bottom of the cavity and directing the light beams towards the outside of the cavity by an inclined mirror placed at the opening.

Thus, a cavity having such a structure makes it possible to transmit information displayed on the screen legibly outside the cavity while protecting the screen located inside the cavity.

According to one implementation, the method includes calibrating the time-of-flight sensor so as to determine the distance interval and the photon amount interval from the detection of the wall of the cavity opposite to the time-of-flight sensor.

The calibration enables, after installation of the sensor in a cavity for example, the recording by the sensor of the position of a wall in order not to mistake an object for this wall during the detection phase and thus facilitates its integration in a detection system including a cavity of variable dimensions.

According to another aspect, a time-of-flight sensor is provided, including emission circuitry configured to emit optical radiation, reception circuitry configured to detect an amount of photons of optical radiation reflected from said at least one object, measurement circuitry configured to measure an amount of photons and a distance between said time-of-flight sensor and said at least one object, and processing circuitry configured to analyze the amount of photons and associated distance so as to determine the presence of at least one object in a detection zone.

According to one embodiment, the processing circuitry includes storage circuitry configured to successively store N values of amounts of photons and associated distances and calculation circuitry configured to calculate a photon amount central trend indicator from the N amounts of photons and a distance central trend indicator from the N distances so that said at least one object is detected according to said central trend indicators calculated.

According to one embodiment, said at least one object is detected when the distance central trend indicators is in in the distance interval and when the photon amount central trend indicator is comprised in a photon amount interval.

According to one embodiment, said at least one object is detected when the central distance trend indicator is lower than a first distance.

According to one embodiment, the photon amount central trend indicator is a median of the N amounts of photons and the distance central trend indicator is a median of the N associated distances.

According to one embodiment, the photon amount central trend indicator is an average of the N amounts of photons and the distance central trend indicator is an average of the N associated distances.

According to another aspect, a detection system is provided including a cavity including an opening through which said at least one object can enter the cavity and a bottom, and a previously mentioned time-of-flight sensor, mounted to a wall of the cavity, the detection zone of the time-of-flight sensor extending between the time-of-flight sensor and a wall of the cavity opposite to the time-of-flight sensor to the bottom of the cavity so as to be able to detect the presence of said at least one object when it is resting on the bottom of the cavity.

According to one embodiment, the cavity includes a screen located at the bottom of the cavity as well as an inclined mirror located at the opening and configured to direct light beams emitted by the screen towards the outside of the cavity.

According to one embodiment, the time-of-flight sensor includes calibration circuitry configured to determine the distance interval and the photon amount interval from the detection of the wall of the cavity opposite to the time-of-flight sensor.

### BRIEF DESCRIPTION OF THE DRAWINGS

Further advantages and characteristics of the invention will become apparent upon examining the detailed description of non-limiting embodiments and implementations and the appended drawings in which:

FIG. 1 is a block diagram of a time-of-flight sensor disclosed herein;

FIG. 2 graphically illustrates the result of the analysis by the processing circuitry of FIG. 1 in the case where no object is detected in the detection zone;

FIG. 3 graphically illustrates the result of the analysis by the processing circuitry of FIG. 1 in the case where an object is detected in the detection zone;

FIG. 4 shows a cross-sectional view of a detection system disclosed herein;

FIG. 5 illustrates an example of a method for detecting at least one object by the time-of-flight sensor of FIG. 1.

### DETAILED DESCRIPTION

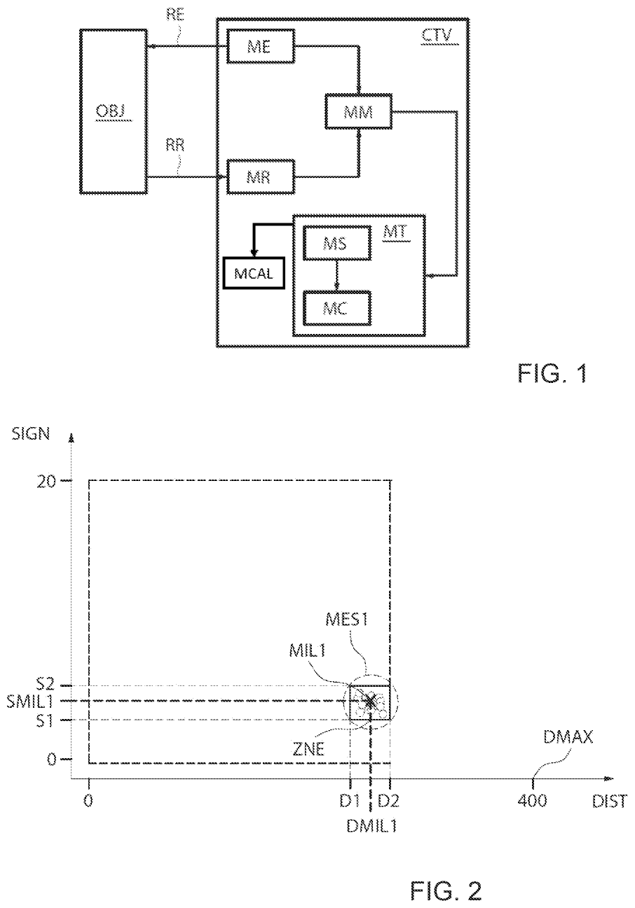

FIG. 1 schematically illustrates a time-of-flight sensor CTV according to one embodiment. The time-of-flight sensor CTV comprises emission circuitry ME configured to emit optical radiation RE, such as an infra-red light wave or a laser beam. The emission circuitry ME may comprise a laser diode able to generate the optical radiation RE continuously or periodically.

The emitted optical radiation RE travels a distance, for example a distance D1 as described later in relation to FIG. 4, until it encounters an object OBJ located in a detection zone DET of the time-of-flight sensor CTV. The optical radiation RE is then reflected by the object OBJ. The time-of-flight sensor CTV comprises reception circuitry MR configured to receive the reflected optical radiation RR continuously or periodically according to the emission mode of the reflected radiation RR. The reception circuitry MR comprises an array of single photon detectors of a single photon avalanche diode (SPAD) type.

The time-of-flight sensor CTV further comprises measurement circuitry MM configured to measure an amount of photons SIGN detected by the reception circuitry MR and a distance DIST between the sensor CTV and the object OBJ. The measurement circuitry MM may be an electronic circuit for conditioning the electrical signal transmitted by the reception circuitry MR. The measurements carried out by the measurement circuitry MM enable the generation of measurement data MES which associate the amount of photons SIGN with the measured distance DIST. For each detection of radiation reflected by an object OBJ, the amount of photons SIGN is measured and a distance DIST of this object from the sensor CTV is determined. The amount of photons SIGN may vary as a function of the characteristics of the object OBJ to be detected, such as the size or shape of the object OBJ.

The time-of-flight sensor CTV also comprises processing circuitry MT configured to analyze the amount of photons SIGN associated with the measured distance DIST so as to determine the presence of at least one object OBJ in a detection zone DET. The processing circuitry MT may be a processor for example. The physical zone covered by the field of view of the time-of-flight sensor CTV, which generally extends to a maximum detection distance DMAX, is called the detection zone DET. The maximum detection distance may depend on various factors related to the environment of the sensor VTC, such as the ambient light, and may also be related to the size of the object to be detected. In particular, the sensor VCT can be configured to detect a coin at a distance of up to 300 mm for example.

The joint analysis of the amount of photons SIGN of the reflected radiation RR and the distance DIST makes it possible to improve the accuracy of the detection of the object OBJ in the detection zone DET. Indeed, the amount of photons SIGN of the reflected radiation RR, like the distance DIST, gives information on the position of the object OBJ, that is, whether it is more or less close to the sensor CTV.

The processing circuitry MT may also receive several values of amount of photons SIGN and distance DIST generated by the measurement circuitry MM when several optical beams are emitted by the emission circuitry ME and received by the reception circuitry MR. Consequently, the analysis can be carried out on the basis of several amounts of photons SIGN and distances DIST measured periodically by the measurement circuitry MM and make it possible to determine the presence of an object OBJ during the entire duration of the emission of the optical radiation.

Besides, the processing circuitry MT comprise storage circuitry MS and calculation circuitry MC.

The storage circuitry MS is configured to successively store N values of amounts of photons and associated distances, where N=15 for example. The storage circuitry MS may be a memory integrated in the time-of-flight sensor CTV such as a volatile memory. The values of amounts of photons SIGN and distance DIST may be generated successively by the measurement circuitry MM over a time window, that is, over a given time interval, and stored periodically in the storage circuitry MS. The number N can be predefined in the algorithm of the time-of-flight sensor CTV.

The calculation circuitry MC is configured to calculate a photon amount central trend indicator and a distance central trend indicator from the values of amounts of photons SIGN and distances DIST previously measured.

More particularly, the photon amount central trend indicator may be an average of the N amounts of photons SIGN stored in the storage circuitry MS and the central distance trend indicator may be an average of the N distances associated with the amounts of photons SIGN and also stored in the storage circuitry MS.

Alternatively, the photon amount central trend indicator is a median of the N amounts of photons SIGN and the distance central trend indicator is a median of the N distances associated with the amounts of photons SIGN.

These two central trend indicators are calculated and then updated as soon as the N measurements of amounts of photons SIGN and associated distances DIST are available in the memory of the time-of-flight sensor CTV.

The central trend indicators can be calculated from a number N of amounts of photons and distances measured successively over a time window, that is, a given time interval, which can be sliding. The time interval during which the measurement is carried out may be longer or shorter depending on the number N of measured amounts of photons and distances to be stored and taken into account in the calculation of the central trend indicators. A high number N of measurement data makes it possible to limit outliers of certain amounts of photons and distances measured in the same time interval and thus to avoid producing an erroneous result.

FIG. 2 graphically illustrates the result of the analysis by the processing circuitry MT in the case where no object OBJ is detected in the detection zone DET.

In the analysis illustrated in FIG. 2, several measurements MES1 have been carried out by the measurement circuitry MM in the absence of objects OBJ in the detection zone DET and projected onto an ordinate axis corresponding to the amounts of photons and onto an abscissa axis corresponding to the distances. Furthermore, the amounts of photons SIGN come from radiation reflected from a cavity wall located in the detection zone DET at a distance comprised in a distance interval, for example between a first distance D1 and a second distance D2 higher than the first distance D1.

The sensor may allow some distance deviations. In particular, the distances DIST measured by the time-of-flight sensor CTV may be slightly below or slightly above the actual distance between the time-of-flight sensor CTV and the wall depending on the conditions under which the radiation is emitted or received for example.

The measured amounts of photons are for example comprised in a photon amount interval, for example between a first amount of photons S1 and a second amount of photons S2 higher than the first amount of photons S1. The photon amount interval and the distance interval are illustrated in FIG. 2 by a zone ZNE. The detection result may therefore be erroneous if the time-of-flight sensor CTV mistakes the wall PAR for an object OBJ to be detected.

The processing circuitry MT can be calibrated so as to define a distance interval and a photon amount interval which are associated with a detection of the wall PAR located facing the time-of-flight sensor CTV.

The first distance D1, the second distance D2, the first value S1 and the second value S2 depend on the position of the wall PAR and, more generally, on the structure in which the time-of-flight sensor CTV is placed, such as the cavity CAV, which is described hereafter in relation to FIG. 4.

The photon amount central trend indicator SMIL1 and the distance central trend indicators DMIL1 are calculated from the different measurements MES1 of amounts of photons and distances. The result of the analysis can be represented graphically by a value MIL1 corresponding to the value of the distance central trend indicator DMIL1 associated with the value of the photon amount central trend indicator SMIL1.

The central distance trend indicator DMIL1 is comprised in the distance interval, that is, between the first distance D1 and the second distance D2, and the photon amount central trend indicator SMIL1 is comprised in the photon amount interval, between the first value S1 and the second value S2 and makes it possible to conclude that there is no object OBJ in the detection zone DET.

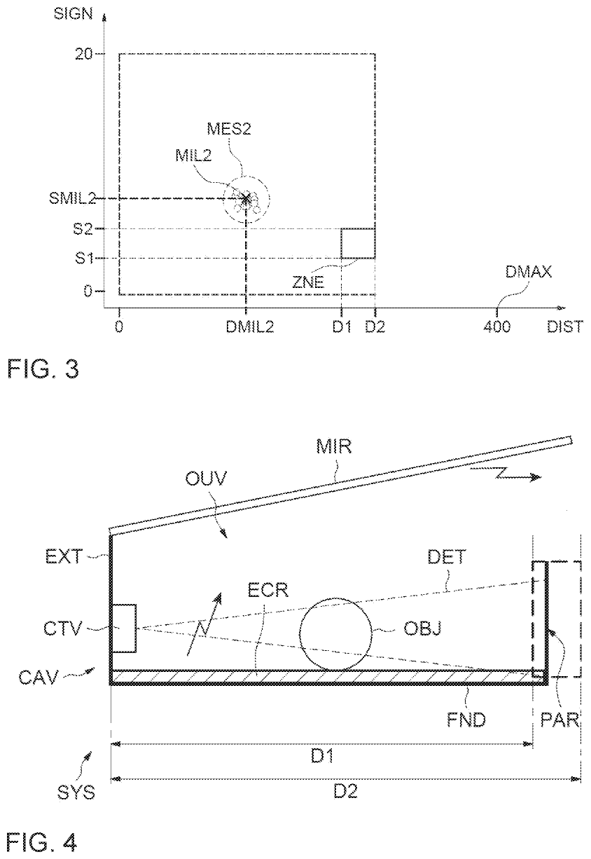

FIG. 3 graphically illustrates the result of the analysis by the processing circuitry MT in the case where an object OBJ is detected in the detection zone DET.

In the analysis illustrated in FIG. 3, several measurements MES2 have been carried out by the measurement circuitry MM during the presence of at least one object OBJ in the detection zone DET and represented on the graph previously described in relation to FIG. 2.

Furthermore, the amounts of photons SIGN come from radiation reflected by an object OBJ located in the detection zone DET at a distance lower than the first distance D1.

The measured amounts of photons SIGN may for example be higher than the second amount of photons S2 and the distances associated with the amounts of photons may be lower than the first distance D1. The photon amount central trend indicator SMIL2 and the distance central trend indicator DMIL2 are calculated from the different measurements MES2 of amounts of photons and distances. The result of the analysis can be represented graphically by a value MIL2 corresponding to the value of the distance central trend indicator DMIL2 associated with the value of the photon amount central trend indicator SMIL2.

The object OBJ is detected in the detection zone DET when the central distance trend indicator DMIL2 is lower than the first distance D1, regardless of the value of the photon amount central trend indicator SMIL2. On the other hand, for an object OBJ located in the vicinity of the wall PAR, for example at a distance DIST comprised in the distance interval, the measurement of the amount of photons SIGN may be advantageous for distinguishing the object OBJ from the wall PAR. When the value of the photon amount central trend indicator SMIL2 calculated from the measurement data MES2 is comprised in another photon amount interval, that is, is lower than the first value S1 or is higher than the second value S2, the central trend indicators make it possible to conclude that at least one object OBJ is present in the detection zone DET.

FIG. 4 shows a cross-sectional view of a detection system SYS. The system SYS comprises the time-of-flight sensor CTV previously described in relation to FIGS. 1 to 3 and a cavity CAV. The cavity CAV includes an opening OUV and a bottom FND. By way of non-limiting example, the cavity CAV may be a space delimited by side walls PAR.

The time-of-flight sensor CTV is mounted to a wall EXT of the cavity, for example a side wall PAR, so that the detection zone DET of the sensor CTV covers the internal space of the cavity CAV, especially the bottom FND. The cavity CAV also has another wall PAR which may be located facing the time-of-flight sensor CTV and which is located in the detection zone DET. The wall PAR is capable of reflecting the optical radiation RE and is therefore detected by the time-of-flight sensor CTV.

The opening OUV is located facing the bottom FND of the cavity CAV. The opening OUV may for example be a slit formed in a wall PAR opposite to the bottom of the cavity. The opening OUV may be shaped to permit an object OBJ having dimensions smaller than the dimensions of the opening OUV to pass therethrough. Such an object may thus enter the cavity CAV through the opening OUV and fall onto the bottom FND of the cavity. Detection of an object OBJ, such as a coin, card or dust particle, may be necessary in some applications when for example the cavity CAV comprises a screen ECR located at the bottom FND of the cavity CAV and an inclined mirror MIR. The screen ECR is configured to emit light beams onto the inclined mirror MIR which is placed at the opening OUV. The mirror MIR is for example attached to a wall EXT of the cavity CAV and is configured to direct the light beams emitted by the screen ECR towards the outside of the cavity CAV.

Thus, a cavity CAV having such a structure makes it possible to transmit information displayed on the screen ECR legibly outside the cavity CAV while protecting the screen ECR located inside the cavity CAV.

Besides, the time-of-flight sensor CTV placed inside the cavity CAV makes it possible, in this structure, to detect the objects OBJ located in the detection zone DET and, more particularly, between the screen ECR and the inclined mirror MIR, which hinder the passage of the light beams emitted by the screen ECR and thus the transmission of information to the outside of the cavity CAV by the mirror MIR. The light beams can be directed by the mirror MIR towards a glass pane (not represented) so as to project the information onto the glass pane. The glass pane can especially be used as a vehicle dashboard. Alternatively, the screen ECR can also emit light beams directed directly towards the dashboard so as to project the information onto the dashboard without using a mirror MIR.

The time-of-flight sensor CTV detects the object OBJ when the latter enters the detection zone DET, especially when the object OBJ is resting on the bottom FND of the cavity CAV. The system SYS may comprise other devices (not represented in the figure) that can receive the measurement data MES from the time-of-flight sensor CTV or possibly a detection signal when the time-of-flight sensor CTV detects the presence of an object OBJ in the cavity CAV.

The system SYS cannot be limited to the embodiment previously described in relation to FIG. 4 and can very well be made with cavities of different aspects and a time-of-flight sensor CTV positioned otherwise while enabling the detection zone DET to cover the internal space sufficiently for the detection of the object OBJ at the bottom FND of the cavity CAV.

Besides, the time-of-flight sensor CTV comprises calibration circuitry MCAL configured to determine the distance interval and the photon amount interval from the detection of the wall PAR of the cavity CAV opposite to the time-of-flight sensor CTV.

The calibration by the calibration circuitry MCAL of the CTV sensor enables, after installation of the CTV sensor in the cavity CAV, the recording by the CTV sensor of the position of the wall PAR in order not to mistake an object OBJ for this wall PAR during the detection phase and thus facilitates its integration in a detection system SYS including a cavity of variable dimension.

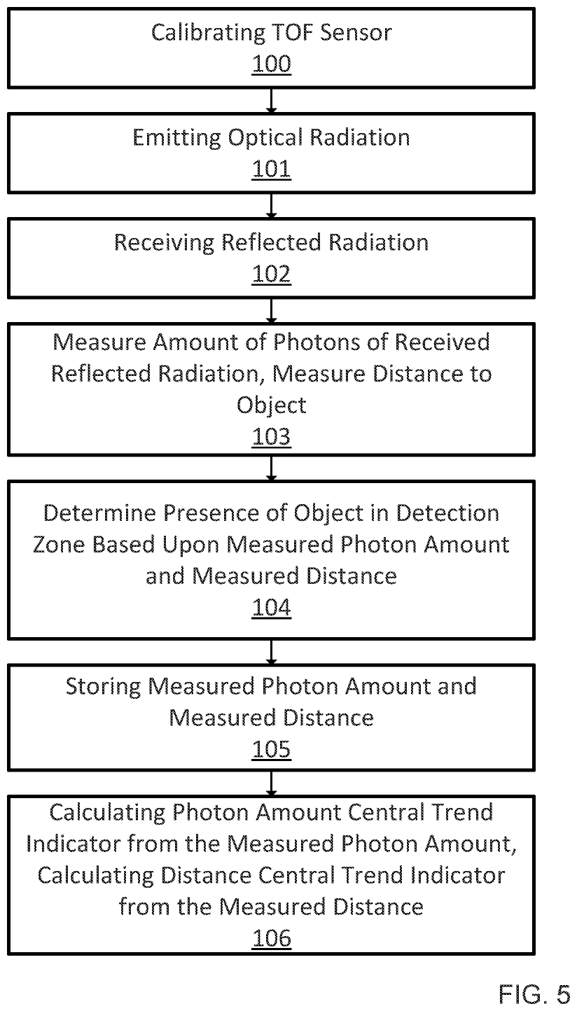

FIG. 5 illustrates an example of a method for detecting at least one object OBJ by the time-of-flight sensor CTV as described above in relation to FIGS. 1 to 4. The method is for example implemented for a detection system SYS as described in relation to FIG. 4, that is, after the installation of the time-of-flight sensor CTV in the cavity CAV.

The method comprises calibrating 100 the time-of-flight VTC sensor so as to determine the distance interval and the photon amount interval from the detection of the wall PAR of the cavity CAV opposite to the time-of-flight VTC sensor.

The method comprises emitting 101 an optical radiation RE by the emission circuitry ME. The optical radiation RE propagates in the cavity CAV until it is reflected by an object OBJ or the wall PAR of the cavity CAV.

The method also comprises receiving 102 an amount of photons SIGN from the reflected radiation RR by the reception circuitry MR.

The method comprises measuring 103 by the measurement circuitry MM the amount of photons SIGN and the distance DIST between the time-of-flight sensor CTV and the object OBJ or the wall PAR.

The method comprises analyzing 104 the amount of photons SIGN and the associated distance DIST so as to determine the presence of at least one object OBJ in the detection zone DET.

The analysis 104 comprises storing 105 N values of amounts of photons SIGN and distances DIST measured and calculating 106 a photon amount central trend indicator from the N amounts of photons SIGN and a distance central trend indicator from the N distances DIST.

In particular, the storage 105 is carried out by the storage circuitry MS which can store the measurement data MES periodically.

The calculation 106 of the central trend indicators is performed by the calculation circuitry MC from the N values of amounts of photons and distances stored in the storage circuitry MS. In particular, the photon amount central trend indicator is an average or median of the N amounts of photons measured and the distance central trend indicator is an average or median of the N distances associated with the amounts of photons.

The analysis 104 determines whether at least one object OBJ is present or not in the detection zone DET according to said central trend indicators calculated. An object OBJ may be detected when the distance central trend indicator value DMIL2 of the N measured distances is lower than the first distance D1 or when the distance central trend indicator value DMIL2 is comprised in the distance interval and when the photon amount central trend indicator value SMIL2 of the N amounts of photons is comprised in the photon amount interval, that is, is lower than the first value S1 or is higher than the second value S2.

Finally, the method comprises calibrating the time-of-flight sensor TFT so as to determine the distance interval and the photon amount interval from the detection of the cavity wall PAR of the cavity CAV opposite to the time-of-flight sensor TFT.

1. A method for detecting at least one object in a detection zone, comprising:
emitting optical radiation using emission circuitry of a time-of-flight sensor;
receiving, by reception circuitry of the time-of-flight sensor, photons of optical radiation reflected by said at least one object;
measuring, using measurement circuitry of the time-of-flight sensor, an amount of photons and a distance between said time-of-flight sensor and said at least one object, and
analyzing the amount of detected photons and the distance so as to determine presence of the at least one object in the detection zone of the time-of-flight sensor.

2. The method according to claim 1, wherein analyzing the amount of photons associated with the measured distance comprises successively storing values of N amounts of photons and N associated distances, calculating a photon amount central trend indicator from the N amounts of photons, and calculating a distance central trend indicator such that said at least one object is detected according to the distance central trend indicator calculated.

3. The method according to claim 2, wherein said at least one object is detected when the distance central trend indicator is comprised in a distance interval and when the photon amount central trend indicator is comprised in a photon amount interval.

4. The method according to claim 2, wherein said at least one object is detected when the distance central trend indicator is lower than a first distance.

5. The method according to claim 2, wherein the photon amount central trend indicator is a median of the N amounts of photons and the distance central trend indicator is a median of the N associated distances.

6. The method according to claim 2, wherein the photon amount central trend indicator is an average of the N amounts of photons and the distance central trend indicator is an average of the N associated distances.

7. A method for detecting at least one object in a cavity including an opening through which said at least one object can enter and a bottom, a time-of-flight sensor being mounted to a wall of the cavity, the time-of-flight sensor having a detection zone extending between the time-of-flight sensor and a wall of the cavity opposite to the time-of-flight sensor to the bottom of the cavity, the method comprising:
emitting optical radiation using emission circuitry of the time-of-flight sensor;
receiving, by reception circuitry of the time-of-flight sensor, photons of optical radiation reflected by said at least one object;
measuring, using measurement circuitry of the time-of-flight sensor, an amount of photons and a distance between said time-of-flight sensor and said at least one object, and
analyzing the amount of detected photons and the distance so as to determine presence of the at least one object in the detection zone of the time-of-flight sensor by successively storing values of N amounts of photons and N associated distances, calculating a photon amount central trend indicator from the N amounts of photons, and calculating a distance central trend indicator such that said at least one object is detected when the distance central trend indicator is comprised in a distance interval and when the photon amount central trend indicator is comprised in a photon amount interval.

8. The method according to claim 7, further comprising emitting light beams from a screen located at the bottom of the cavity and directing the light beams towards an outside of the cavity by an inclined mirror placed at the opening.

9. The method according to claim 7, further comprising calibrating the time-of-flight sensor so as to determine the distance interval and the photon amount interval from the detection of the wall of the cavity opposite to the time-of-flight sensor.

10. A time-of-flight (TOF) sensor, comprising:
emission circuitry configured to emit optical radiation;
reception circuitry configured to detect photons of optical radiation reflected from at least one object;
measurement circuitry configured to measure an amount of photons and a distance between said time-of-flight sensor and said at least one object, and
processing circuitry configured to analyze the amount of photons and the distance so as to determine presence of the at least one object in a detection zone of the time-of-flight sensor.

11. The TOF sensor according to claim 10, wherein the processing circuitry comprises storage circuitry configured to successively store values of N amounts of photons and N associated distances and calculation circuitry configured to calculate a photon amount central trend indicator from the N amounts of photons and to calculate a distance central trend indicator from the N associated distances such that said at least one object is detected according to said distance central trend indicator calculated.

12. The TOF sensor according to claim 11, wherein said at least one object is detected when the distance central trend indicator is comprised in a distance interval and when the photon amount central trend indicator is comprised in a photon amount interval.

13. The TOF sensor according to claim 11, wherein said at least one object is detected when the distance central trend indicator is lower than a first distance.

14. The TOF sensor according to claim 11, wherein the photon amount central trend indicator is a median of the N amounts of photons and the distance central trend indicator is a median of the N associated distances.

15. The TOF sensor according to claim 11, wherein the photon amount central trend indicator is an average of the N amounts of photons and the distance central trend indicator is an average of the N associated distances.

16. A detection system, comprising:
a cavity including an opening through which at least one object can enter the cavity and a bottom; and
a time-of-flight sensor mounted to a wall of the cavity, a detection zone of the time-of-flight sensor extending between the time-of-flight sensor and a wall of the cavity opposite to the time-of-flight sensor to the bottom of the cavity so as to be able to detect presence of said at least one object when it is resting on the bottom of the cavity;
wherein the time-of-flight sensor comprises:
emission circuitry configured to emit optical radiation;
reception circuitry configured to detect an amount of photons of optical radiation reflected from the at least one object;
measurement circuitry configured to measure an amount of photons and a distance between said time-of-flight sensor and said at least one object, and
processing circuitry configured to analyze the amount of photons and the distance so as to determine presence of said at least one object in a detection zone of the time-of-flight sensor.

17. The detection system according to claim 16, wherein the cavity comprises a screen located at the bottom of the cavity as well as an inclined mirror placed at the opening and configured to direct light beams emitted by the screen towards an outside of the cavity.

18. The detection system according to claim 16, wherein the processing circuitry comprises storage circuitry configured to successively store values of N amounts of photons and N associated distances and calculation circuitry configured to calculate a photon amount central trend indicator from the N amounts of photons and to calculate a distance central trend indicator from the N associated distances such that said at least one object is detected according to said distance central trend indicator calculated.

19. The detection system according to claim 18, wherein said at least one object is detected when the distance central trend indicator is comprised in a distance interval and when the photon amount central trend indicator is comprised in a photon amount interval.

20. The detection system according to claim 19, and wherein the time-of-flight sensor comprises calibration circuitry configured to determine the distance interval and the photon amount interval from the detection of the wall of the cavity opposite to the time-of-flight sensor.

21. The detection system according to claim 18, wherein said at least one object is detected when the distance central trend indicator is lower than a first distance.

22. The detection system according to claim 18, wherein the photon amount central trend indicator is a median of the N amounts of photons and the distance central trend indicator is a median of the N associated distances.

23. The detection system according to claim 18, wherein the photon amount central trend indicator is an average of the N amounts of photons and the distance central trend indicator is an average of the N associated distances.
